(19) United States
(12) Patent Application Publication
(10) Pub. No.: US 2014/0317537 A1
(43) Pub. Date: Oct. 23, 2014

(54) BROWSER BASED APPLICATION PROGRAM EXTENSION METHOD AND DEVICE

(71) Applicant: Tencent Technology (Shenzhen) Company Limited, Guangdong (CN)

(72) Inventors: Hang Dong, Guangdong (CN); Zhihui Tan, Guangdong (CN); Kaijie Cai, Guangdong (CN); Xinqiu Xie, Guangdong (CN); Peng Wang, Guangdong (CN); Kui Huang, Guangdong (CN); Wenze Yang, Guangdong (CN); Bin Li, Guangdong (CN)

(73) Assignee: Tencent Technology (Shenzhen) Company Limited, Guangdong (CN)

(21) Appl. No.: 14/129,880

(22) PCT Filed: Dec. 20, 2012
(86) PCT No.: PCT/CN2012/087032

§ 371 Date: Dec. 27, 2013

(30) Foreign Application Priority Data
Dec. 22, 2011 (CN) 201110434701.2
Dec. 23, 2011 (CN) 201110439649.X

(51) Int. Cl. G06F 3/0484

(52) U.S. Cl. CPC G06F 3/0484
USPC 715/760

(57) ABSTRACT

A browser based application program extension method and device are provided. In response to a request to activate an application program, a page file and a browser core may be loaded. A script object may be embedded into the browser core to interact with other serving assemblies in an operation environment of the application program. The browser core may parse the page file and generate and display a corresponding application interface. The script object may receive a request from the application interface and invoke a serving assembly according to the request. The script object may return an invoked result to the application interface. Thus, the application program may be developed by combining web technology with the browser core. This may shorten application program development period and reduce development difficulty. Further, the application program may be used in any operating system without extra development effort.

### FIELD

The present invention relates to the field of application program development, and in particular to an extension method and device for a browser-based application program.

### BACKGROUND

Generally, various applications or application programs may be installed on various intelligent terminals such as computers, tablets and smart phones. The various application programs may implement different functions and provide different interface styles. For example, Microsoft Word provides functionality to edit document files, and Adobe photoshop provides functionality to create and edit images.

In a traditional application program development life-cycle, development of an application program interface, also referred to as an application interface, or simply an interface, may consume large amount of manpower and time. In addition, if an application program is to be published for different operating systems, multiple interfaces may have to be developed for the different operating systems, potentially resulting in a complex process and a long development cycle.

### SUMMARY

In order to solve the problems of the complex development process and long development cycle, an extension method and an extension device for a browser-based application program are provided. Some embodiments of the extension method and the extension device illustrating the technical solutions are described below.

In one aspect, an extension method for a browser-based application program may include loading a page file, loading a browser core and embedding a script object into the browser core if a start request of the application program is received. The script object may be adapted to interact with other service component in a running environment of the application program. The extension method may further involve parsing the page file by the browser core, and generating and displaying a corresponding application interface. Further, according to the method, a request from the application interface may be received, and the service component according to the request may be called. The script object may return a call result to the application interface.

In another aspect, an extension device for a browser-based application program may include a main process module, a loading module, a browser core, a script object processing module and an interface processing module. The main process module may be adapted to call the loading module if a start request of the application program is received. The loading module may be adapted to load the browser core, embed the script object processing module into the browser core, load a page file according to the start request and transfer the loaded page file to the browser core. The browser core may be adapted to parse the page file, generate an application interface and transfer the application interface to the interface processing module. The interface processing module may be adapted to display the application interface. The script object processing module may be adapted to receive a request from the application interface, call a server component according to the request, and return a call result to the application interface.

A few advantages of the technical solutions provided by the embodiments of the present invention are discussed further. Other advantage of the extension method and device would be obvious to one stilled in the art upon reading the description of the following embodiments. A page file and a browser core may be loaded in a client process. A client interface may be generated and a script object obtained by parsing the page file by the browser core. A script engine of the browser core may call or execute a service component according to the script object or program instructions for service in the generated client interface. In this way, a client combining a web technique and the browser core may be achieved. The client interface may be generated after the page file is parsed by the browser core. Thus, development code or program instructions for the interface may not have to be written in a development kit separately. Therefore, the large amount of work for the interface development may be simplified because of the browser core, and the development cycle greatly shortened. In addition, the browser core may perform interface drawing based on elements in the page file, thus, not being limited to a type of operating system. Consequently, developed client may be applied to any operating system, and different developments for different operating systems are unnecessary. Thus, the development process may be further simplified, the development difficulty reduced, and the development efficiency vastly improved.

### BRIEF DESCRIPTION OF THE DRAWINGS

The accompanying drawings are to be used in conjunction with the description of the embodiments described briefly as follows, so that the technical solutions according to the embodiments of the present invention become clearer. It is obvious that the accompanying drawings in the following description are only some embodiments of the extension method and extension device and other drawings may be obtained by those skilled in the art based on these without any creative labor.

FIG. 1 is a flow chart of an example operation of an example extension method for a browser-based application program;

FIG. 2 is a flow chart of an example operation of an example extension method for a browser-based application program;

FIG. 3 is a schematic diagram of an exemplary interface displayed by an example extension method for a browser-based application program;

FIG. 4 is a schematic diagram of an example extension method for a browser-based application program;

FIG. 5 is a flow chart of an example operation of an example extension method for a browser-based application program;

FIG. 6 is a schematic diagram of an exemplary interface displayed by an example extension method for a browser-based application program;

FIG. 7 is a flow chart of an example operation of an example extension method for a browser-based application program;

FIG. 8 is a flow chart of an example operation of an example extension method for a browser-based application program;

FIG. 9 is a schematic diagram of an example extension device for a browser-based application program; and

FIG. 10 is a schematic diagram of an example browser core of an example extension device.

### DETAILED DESCRIPTION

In order to make the purpose, technical solutions and advantages of the present invention clearer, embodiments of the present invention are described in further detail below in conjunction with the accompanying drawings.

The embodiments described further relate to a browser core and a script engine. The browser core refers to “Rendering Engine” or “Interpretation Engine”, which may interpret webpage grammar and render a webpage. The webpage grammar may include, for example, HTML (Hypertext Markup Language), and JS (JavaScript) flash or any other similar web-based technology. Therefore, the browser core may be a rendering engine used by a browser. The script engine may be an interpreter of computer programming language, such as PHP (Hypertext Preprocessor), JS, ASP (Active Server Page) or any other programming language which may be used for developing a website. The script engine may interpret a program text entered by a user into machine code executable by a computer, so as to implement a series of functions.

### First Embodiment

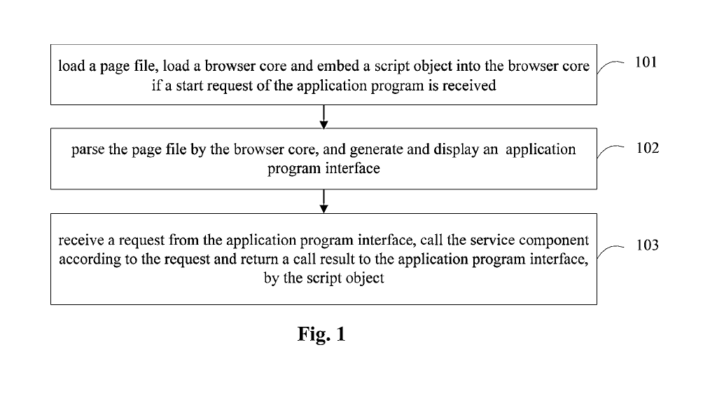

Referring to FIG. 1, an extension method for a browser-based application program, according to a first embodiment may include the following steps 101 to 103.

Step 101, may involve loading a page file, loading a browser core and embedding a script object into the browser core if a start request of the application program is received.

In Step 102, the page file may be parsed by the browser core, and an application interface, or an interface such as a user interface, may be generated and displayed.

Step 103, may include receiving a request from the application interface, calling a service component according to the request and returning a call result to the application interface, by the script object.

Here the page file may refer to a file containing information related to the application interface. The related information may include but is not limited to, element layout, interface style and button operation of the application interface. The information may describe the application interface, and thus the application interface may be drawn and/or displayed according to the information. The page file may be, for example, a HTML file.

In a case that the page file is a HTML file, step 102 may further include the browser core parsing the HTML file, reading CSS (Cascading Style Sheet) and JS specified in the HTML file, and drawing and/or displaying the application interface according to a markup element and the CSS of the HTML file.

The markup element of the HTML file may describe element layout of the interface, the CSS may describe style of the interface, and JS may describe control operation of the interface.

The page file is not limited to the HTML file, but also may be, for example, a dynamic script file in PHP or ASP format. In such a case, the dynamic script file may be first interpreted into a HTML file by the script engine embedded in the browser core. The application interface may then be generated by parsing the HTML file by the browser core according to the above mentioned process of step 102.

Further, if different interfaces are to be developed for the application program, different page files may be created and different application interfaces may be obtained corresponding to the different page files. Thus, personalized demands may be fully satisfied. In addition, compared with the traditional way of modifying the source code of the interface, the application interface may be changed by creating a different page file, which is simple and reduces the workload greatly.

The script object may include a built-in script object of the script engine and/or a user-defined script object. The user may also define different script objects as per the user's preference, and the script engine may embed these user-defined script objects into the running environment and call the service component by these script objects. The script engines of different browser cores may embed the script object in different manners. For example, the script engines of Internet Explorer (IE) browser, Chrome browser and Firefox browser may embed the script object in different manners. The detailed description thereof is readily available and not described in this document.

The service component may include a general-purpose service component provided by an operating system and/or an extended service component. Since functions of a general-purpose service components are generally finite, the extended service components may be used to implement various required functions, including but not limited to a function for accessing a file, a function for creating a process or a thread, or a function for establishing TCP (Transmission Control Protocol) or UDP (User Datagram Protocol) communication with another client, or any other function. For example, a transfer of a file between two clients may be achieved by extending a network service component and a storage service component, which has a high practicability.

As per the above method, the page file and the browser core may be loaded in the application program process, the application interface generated and a script object obtained by parsing the page file by the browser core. Further, the service component may be called according to the script object by the script engine in the browser core, and a corresponding service may be provided in the application interface. In this way, an application program development combining the web technique and the browser core may be achieved. The application interface may be generated after the page file is parsed by the browser core, so that code or program instructions for the interface need not to be written in the development kit separately. Thus, the large amount of work for the interface development may be simplified, and the development cycle greatly shortened. In addition, the browser core may perform interface display and/or drawing based on elements in the page file, which is not limited to the type of the operating system since the web technique is used, so that the developed application program may be applied to any operating system. Thus, separate developments for different operating system are unnecessary. Therefore, the development process may be greatly simplified, the development difficulty reduced, and the development efficiency vastly improved.

Furthermore, compared to traditional webpage application programs, the browser-based application program may be provided with a function of accessing other service components in the operating system by providing an extra script object in the browser core, according to one example extension method. For example, a function for accessing a file, a function for creating a process or a thread, or a function for establishing a TCP or UDP communication with other client, may be provided which may not be supported by the browser by default.

### Second Embodiment

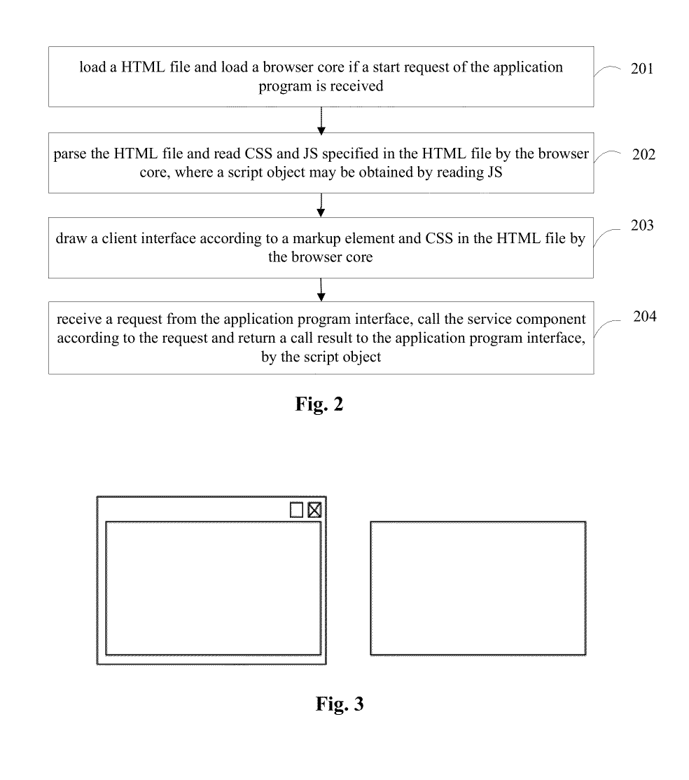

Referring to FIG. 2, an example extension method for a browser-based application program may include the following steps 201 to 204.

Step 201 may involve, loading a page file and a browser core if a start request of the application program is received. The page file may be a HTML file.

The page file and the browser core may be loaded by a loader.

Step 202 may involve, parsing the HTML file and reading CSS and JS specified in the HTML file by the browser core.

The CSS and JS may be used by the page to indicate how the page is to be drawn and are generally specified in the HTML file as described earlier.

Step 203 may involve drawing and/or displaying an application interface according to the markup element and/or the CSS of the HTML file. The interface may be drawn and/or displayed by the browser core.

The application interface may be drawn and obtained in an application program window by rendering the application interface according to the markup element and the CSS of the HTML file by the browser core. The default application program window may have a background or frame. The application program window may be a window created along with the creation/initialization of the application program process, and the application program window may be a carrier of the application interface.

Further, as shown in FIG. 3, two windows may be created by the browser core. An interface with a unified frame (which may be similar to a page viewed by the browser normally, with interface elements such as a toolbar of the browser itself being included) is shown on the left of FIG. 3, and an interface without a frame (which only includes the page itself, without other interface element) is shown on the right of FIG. 3. However, both interface styles of the above two windows may be different from that of a normal client application interface. In order to make the browser-based application have a style similar to that of the normal client application, the following window drawing method may be adopted, without using a built-in window style of the browser core.

A rendered picture of a page may be obtained from the browser core, and a corresponding irregular and partly transparent window may be created according to the rendered picture. In an example implementation, a background of the page may be completely transparent. Corresponding page elements may be rendered by the browser core and a bitmap with a transparent channel may finally be obtained. A bitmap with a transparent channel may be assigned to a window by using functions provided by the operating system. Thus, the irregular and partly transparent window may be achieved. From the point of visual effect, the browser-based webpage content may achieve a true window style.

Step 204 may involve receiving a request from the application interface, calling the service component according to the request, and returning a call result to the application interface by the script object.

The script object may include a built-in script object of the script engine and/or a user-defined script object. The service component may include a general-purpose service component provided by the operating system and/or an extended service component, as described earlier.

Alternatively, or in addition, a plug-in may be used to extend a browser and to provide corresponding service in the application interface. The plug-in may include but is not limited to, ActiveX plug-in of IE browser and NP (Netscape Plugin) of other browser, which may provide various additional functions in the application interface. If this browser extension technique, based on a plug-in, is used, code for the plug-in has to be written separately. Further, the plug-in may have to be installed, and the used plug-in may have to be specified in the page file. Thus, compared to using a plug-in, the technique of calling a service component by a script object may be easier to use. Further yet, calling a service component by a script object may be more secure since, an access range and access authority of the script may be completely controlled by embedding the script object.

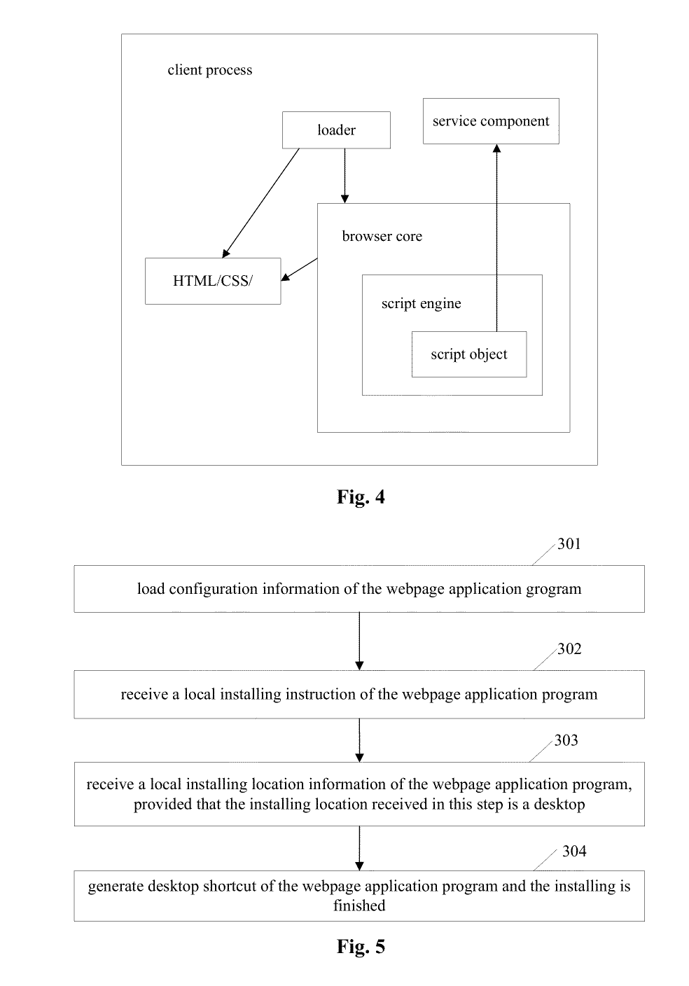

FIG. 4 is a schematic diagram of an exemplary flow of the above method, where a loader performing a loading operation is taken as an example for illustration. In the application program process, a loader may first load a HTML file in the browser core, and then may notify the browser core. The browser core, in response, may parse the HTML file. The browser core may obtain a script object by parsing the HTML file and the specified CSS and JS. The browser core may then draw an application interface according to the HTML and the CSS. The script engine in the browser core may call a service component according to the script object, and may provide a corresponding service in the application interface.

Based on FIG. 1 or FIG. 2, the method may further include, after loading the page file, reading version information of the application program in the page file. The method may continue by querying a server to check if a later version of the application program exists and/or is available. If a later version exists and/or is available, the method may involve prompting the user whether to download the later version of the application program, and downloading a page file of the later version of the application program from the server. The user may have to select to download the later version of the application program. Alternatively, or in addition, by parsing the version information of the page file, it may be determined whether the later version of the application program exists, and the page file of the later version may be downloaded according to the user's preference. Therefore, the version of the application program may be updated in a timely manner. Moreover, if a later version of the application program does not exist, extra loading operation may not be performed, thus reducing network traffic to the server.

The version information may be determined each time the page file is loaded, or the version information may be determined periodically, or any other technique may be used to check the version.

In some embodiments, the above step may be performed only for the cases where an update may be needed, for example, where the page file is stored in a local storage or a personal storage space. If the page file is provided via the network by an application program publisher, the above updating operation may not be needed since the published may provide the latest version by default.

Alternatively, or in addition, in order to increase security, the page file may be an encrypted page file, and correspondingly loading the page file may include decrypting the encrypted page file and loading the decrypted page file.

For example, in loading a latest version of the page file from the server, the page file may be transferred in a ciphertext manner. This may prevent the page file from, for example, being intercepted by an illegal user and being modified viciously, thus improving the security.

The service component may be one of a network service component, a storage service component, a process or thread service component or a media service component. The network service component may provide network communication function, such as a function for establishing a TCP or UDP connection between clients. The storage service component may provide a reading and writing function. The process or thread service component may provide a process or thread creating function. The media service component may provide a media file accessing function.

The page file and the browser core may be loaded in the application program process, and by parsing the page file by the browser core, a corresponding application interface may be generated and a script object obtained. The script engine in the browser core may execute a service component according to the script object to provide a service corresponding to the service component via the application interface. Therefore, application program development may be achieved by combining the web technique and the browser core, and a reliable solution for quickly building an application program may be provided.

The application program interface i.e. the application interface, may be generated after the page file is parsed by the browser core. Thus, separate code for the interface need not to be written using a development kit or any other technique. Consequently, a large amount of work for the interface development may be simplified by using the browser core, and the development cycle may be greatly shortened. In addition, the interface may be drawn and/or displayed by the browser core based on elements in the page file. This way, by using the web technique, a developer may not be limited to the operating system, and may ignore the details of the platform. The interface may be described by a simple label, and the actual drawing and/or displaying of all elements may be implemented by the browser core. Therefore, the workload may be greatly reduced. Further, a developer may only consider the HTML standard rather than numerous development platforms and SDKs (Software Development Kits) of various operating systems. The developed application program may be applied to any operating system, without a need to develop different versions of the application program for different operating systems, thus greatly simplifying the development process, reducing the development difficulty and improving the development efficiency.

In addition, in this method, accessing a resource of the operating system may be controllable by calling a component by the script object. The user may set different script objects according to preferences and/or requirements at a particular on security level and may selectively call the service component. Therefore, the security of operating system resource access may be improved, by preventing access to all resources of the operating system. Typically, resources of the operating system may be accessed by calling SDK of the operating system. Thus, by using the script object may reduce risky operations, and improve the security.

### Third Embodiment

FIG. 5 is a flow chart of an exemplary operation of an example extension method for a browser-based application program. Referring to FIG. 5, the method may include the following steps 301 to 304.

Step 301 may include, loading an application program file. The application program file may include a page file and configuration information.

Step 302 may include, installing an application program according to the loaded application program file.

The installing of the application program may substantially refer to storing necessary files for running the application program, and providing an entry for accessing the application program in the running environment of the application program. The application program may be started via the entry by the user conveniently. For example, configuration information and/or other program files of the application program may be stored in a file folder named according to an identifier (ID) of the application program; or the configuration information and/or other program files of the application program may be stored in a shared storage space located according to the identifier of the application program.

By taking Windows operating system as an example, the installing of the application program may include creating a program catalogue, generating in the program catalogue, files necessary for running the application program, registering in the operating system to be associated with services or files in some format, and creating a start item in the system.

A desktop space may be maintained after each of the current various window-based operating systems starts, to facilitate starting the application program and managing the started application program window. By taking Windows operating system as an example, the desktop space may include, for example, a desk and a program start bar. In addition, besides the desktop space provided by the operating system itself, a user-defined desktop space may also be maintained by some third party application. The user-defined desktop space may service as a window of the desktop space of the system to run, or may completely replace the desktop space of the system and service as an entry of various application programs and a window managing space.

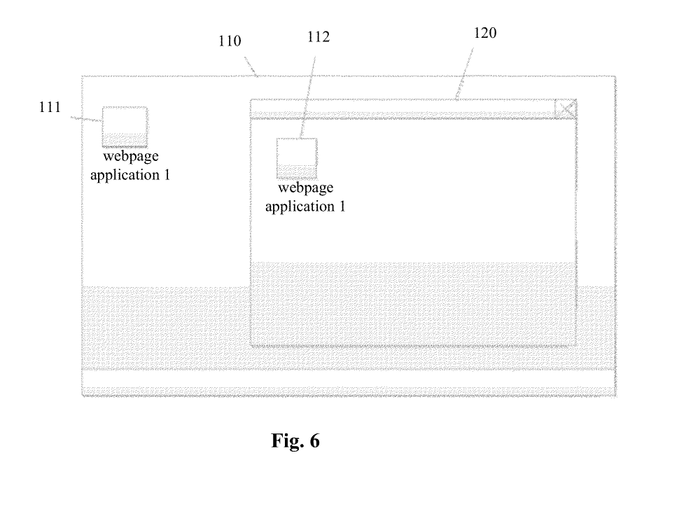

Referring to FIG. 6, for example, a first desktop space 110 may be a desktop space provided by the operating system, and a second desktop space 120 may be a desktop space maintained by a main process module. One or more shortcuts of the browser-based application program may be provided in the second desktop space 120. After the user clicks the shortcut, corresponding browser-based application program may be started. The interface windows of the browser-based application program may be managed by the second desktop space 120.

Upon installation of the browser-based application program, by default, a corresponding start item (for example, shortcut 112) may only be generated in the second desktop space 120. However, a corresponding start item (for example, shortcut 111) may also be generated in the first desktop space 110 for obtaining a flow similar to that of a normal client application program in the first desktop space. Therefore, upon installation of the browser-based application program by the user, besides installing in the second desktop space 120 by default, the following step 303 may also be performed.

According to Step 303, it may be judged whether the application program is to be installed in another desktop space, and step 304 may be performed to install the browser-based application program in the other desktop space. The installation may be deemed complete if the application program is not to be installed in the other desktop.

The above mentioned other desktop space may be, for example, the first desktop space 110 shown in FIG. 6. If the installation is to be performed in the first desktop space, a first start item may be generated in the first desktop space.

It is to be noted that the browser-based application program itself may not include any directly executable file (for example, .exe file). Moreover, since some functions may depend on the script object of the browser core extension, the page file of the application program opened by calling or executing the browser-based program directly in the first desktop space 110, the browser-based program may not run normally. In order to solve the problem, a loader may be needed to start indirectly. The loader may be a process running separately, or may be embedded in a main process module. Thus, the first start item 111 may point to the loader with the application program identification as a parameter. For example, WebAppLoader.exe/appid=xxx may be stored as a target parameter of the first start item 111. The WebAppLoader.exe may be the main process module.

In the extension method for the browser-based application program of such an embodiment, by generating start items pointing to the browser-based application program in different desktop spaces, the browser-based application program may be started conveniently in different desktop spaces, since the browser-based application program may be started just like any other client program, which is more convenient.

### Fourth Embodiment

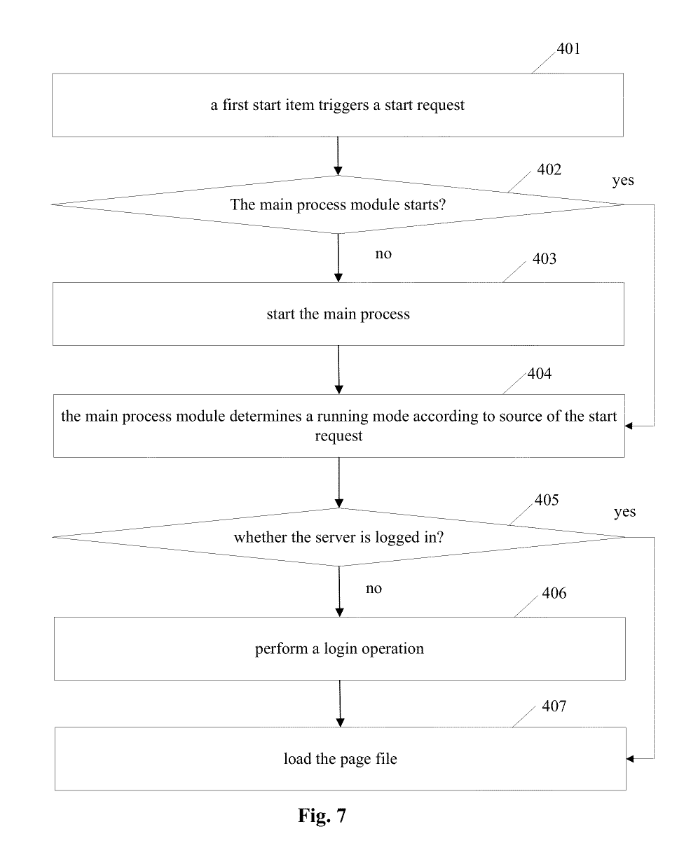

In another example extension method for a browser-based application program the step 101, described earlier and shown in FIG. 1, may additionally include the following steps 401 to 407 as shown in FIG. 7.

In Step 401, the first start item 111 may trigger a start request. For example, the user may double-click the shortcut 111 in the first desktop space 110, to trigger the start request of the application program.

In Step 402, it may be judged whether the main process module is to be started. Step 403 may be performed to start the main process module followed by step 404. Alternatively, Step 404 may be performed directly after Step 402, as shown in FIG. 7.

In Step 404, the main process module may determine a running mode according to a source of the start request. Determining the running mode refers to setting parameters for subsequent processes such as loading the page file and displaying the application program interface. In the example operation of the embodiment discussed below, the start request is from the first desktop space 110. As described earlier, if the second desktop space 120 is being displayed, there will be a big difference from the starting process of the application program in the first desktop space 110, which may not meet usage habits and expectations of the user. Therefore, if the start request is from the first start item 111, the main process module may be run in the background, and the application program interface in step 102 may be displayed in the first desktop space 110. If the start request is from the second start item 112, the application interface may be displayed in the second desktop space 120.

In addition, different interface styles may be displayed for different desktop spaces. The application interface may be adjusted to a first interface style matched with the first desktop space 110 if the start request is from the first start item 111, and the application interface may be adjusted to a second interface style matched with the second desktop space 120 if the start request is from the second start item 112. In the first interface style, for example, the browser-based application program's interface may be drawn and/or displayed to have a style similar to the normal style of other client application programs in the first desktop space 110, to make the browser-based application program look and feel similar to normal client application programs.

The method according to the fourth embodiment may further include Step 405, to check whether the server is logged in. Step 406 may be performed to log into the server if the server is not logged in. Step 407 may be performed to load the page file once the server is logged in.

It is to be noted that during the login operation, since the running mode may be different based on different source of the start request, user may be provided different interfaces. For example, if the start request is from the first start item 111, only a login interface may be displayed, and other interface, such as other interface elements in the second desktop space 120 shown in FIG. 6, may not be displayed.

In the extension method for the browser-based application program according to the embodiment, the browser-based application program may run in a different running mode according to the different source of the start request, to make the application program match with the corresponding desktop space to the greatest extent, so as to avoid affecting the usage habits of the user.

### Fifth Embodiment

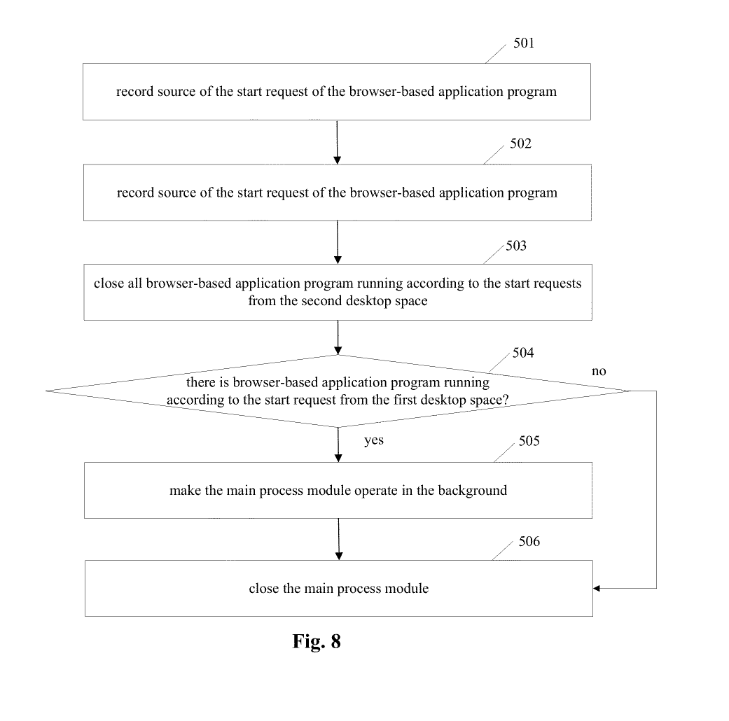

In yet another example extension method for a browser-based application program, the following steps 501 to 506, shown in FIG. 8, may be performed.

Step 501, may involve recording source of the start request of the browser-based application program. The start request for example, may be from the start item of the first desktop space 110 or the second desktop space 120. Moreover, the main process module may need to maintain the second desktop space 120 and process the start request of the application program from the first desktop space 110.

Step 502, may involve receiving an exit request of the main process module. For example, the user may select to exit from the second desktop space 120 in the second desktop space 120. In this case, the exit request of the main process module may be triggered.

Step 503, may involve closing all browser-based application programs running according to the start request from the second desktop space 120.

Step 504, may involve judging whether there is a browser-based application program running according to the start request from the first desktop space 110, performing 505 if there is, and otherwise performing 506.

Step 505, may involve controlling the main process module to run in the background, i.e., hiding the second desktop space 120.

Step 506, may involve closing the main process module.

In the extension method for the browser-based application program according to the embodiment, the browser-based application programs running in different desktop spaces may be processed differently when closing, thus providing more flexibility.

### Sixth Embodiment

An exemplary extension device for a browser-based application program is described. Referring to FIG. 9, the extension device may include a main process module 610, a loading module 620, a browser core 630, a script object processing module 640 and an interface processing module 650.

The main process module 610 may call the loading module 620 for execution if a start request of the application program is received. The main process module 610 may include a request receiving unit 611, a login unit 612 and an exit unit 613. The request receiving unit 611 may receive the start request of the application program, and call the login unit 612 and/or the exit unit 613 as may be necessary. The login unit 612 may judge whether the service is logged in, perform a login operation if the service is not logged in and obtain notification information returned from the service if the service is logged in successfully. The exit unit 613 may judge whether there is a browser-based application program running according to the start item from the first desktop space 110 after receiving an exit request, and if there is, the exit unit 613 may make the main process module operate in the background. In addition, the main process module 610 may also maintain the second desktop space 120 as shown in FIG. 6.

The loading module 620 may load the browser core 630, embed the script object processing module 640 into the browser core 630, load the page file according to the start request and transfer the loaded page file to the browser core 630. The loading module 620 may run separately, or may be embedded in the main process module 610.

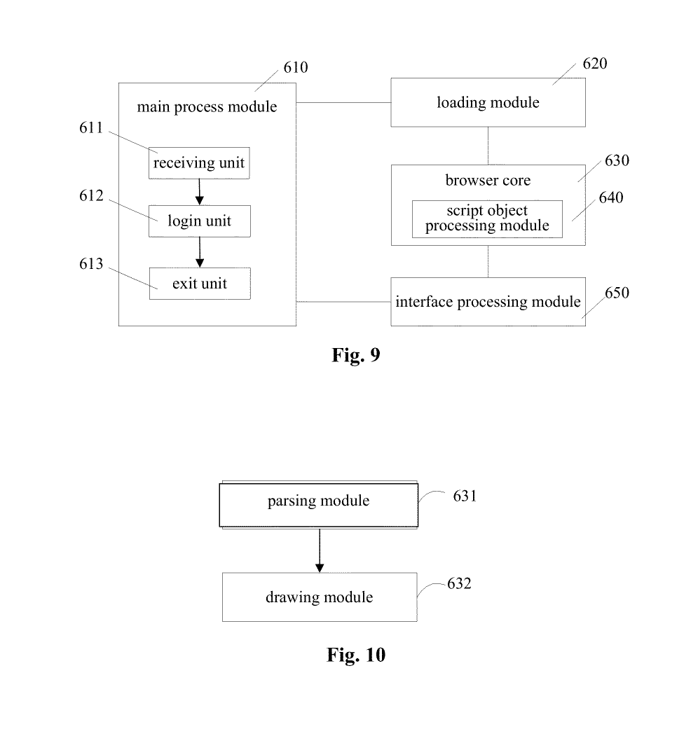

Referring to FIG. 10, the page file may be a hypertext markup language HTML file. The browser core 630 may include a parsing module 631, adapted to parse the HTML file, read the cascading style sheet (CSS) and the script (JS) specified in the HTML file, and obtain a script object according to the JS. The browser core 630 may further include a drawing module 632, adapted to draw the client interface according to a markup element and the CSS in the HTML file read by the parsing module 631.

In the embodiment, the drawing module 632 may be further adapted to generate a rendered picture of the interface according to the markup element and the CSS in the HTML file read by the parsing module 631.

The browser core 630 may parse the page file, generate the application interface, and transfer the application interface to the interface processing module 650. The interface processing module 650 may display the application interface, receive a user's input and respond to the user's input.

The script object processing module 640 may receive a request from the application interface, call a service component according to the request, and return a call result to the application interface. The service component may provide functions not supported by the browser core 630. For example, the service component may provide a function for directly establishing a network communication connection such as a TCP or UDP connection, a function for directly reading and writing a file, a function for creating a process, or a function for accessing a media file. In other words, the service component may include at least one of a network service component, a storage service component, a process or thread service component and a media service component.

The loading module 620, after the page file is loaded, may read version information of the client in the page file. The loading module 620 may query a server about availability of a later version of the application program. The loading module 620 may prompt the user to download the later version of the application program. The loading module 620 may download the page file of the later version of the application program from the server if and when the user selects to download the later version of the application program.

The page file may be an encrypted page file, and the loading module 620 may decrypt the encrypted page file before loading the page file.

The extension device for the application program may further include an installing module, which may perform an installation operation. Specifically, the installing module may generate the first start item 111 pointing to the application program in the first desktop space 110. The start request may be triggered if and when the first start item 111 is executed. The installing module may generate a second start item 112 pointing to the application program in the second desktop space 120. The start request may also be triggered if and when the second start item 112 is executed. The installing module may further store configuration information and/or other program files of the application program into a file folder named according to an identifier of the application program. In addition, or alternatively, the installing module may store configuration information and/or other program files of the application program into a shared storage space located according to the identifier of the application program.

The main process module 610 may identify or determine the source of the start request. The interface processing module 650 may display the application interface in the first desktop space 110 if the start request is from the first start item 111, and display the application interface in the second desktop space 120 if the start request is from the second start item 112.

The interface processing module 650 may adjust the application interface to a first interface style matched to the first desktop space 110 if the start request is from the first start item 111, and adjust the application interface to a second interface style matched to the second desktop space 120 if the start request is from the second start item 112.

An example extension device may perform any of the embodiments described in this document, or combinations thereof. In addition, or alternatively, the example extension device may perform other operations and method not described in this document.

In client or an application developed according to the above embodiments, after loading the page file and the browser core in a client process, a client interface may be generated and a script object obtained based on parsing the page file by the browser core. A service component may be called according to the script object by the script engine in the browser core. A service corresponding to the service component may be provided via the client interface. Thus, the client may be developed by combining a web technique and the browser core. Therefore, a reliable solution for quickly developing a client is provided by the techniques described in the above embodiments.

Further, the client interface may be generated after the page file is parsed by the browser core. Thus, code for the interface need not to be written or developed during development of the client. Typically, the code for the interface may be written separately based on a development kit or other resources of a operating system. Thus, large amount of work for the interface development is simplified because of the advantageous use of the browser core as described in the embodiments. Consequently, the development cycle for the client is greatly shortened. In addition, the interface is drawn by the browser core based on the element in the page file, using a web technique, and thus, is not limited to the operating system. Hence, the developer of the client can ignore the details of the operating system platform. The interface may be described by a simple label, and the actual drawing of all elements may be handled by the browser core. Therefore, the workload is further reduced, and the developer can focus on the HTML standard instead of the development platforms and SDKs (Software Development Kits) of various operating systems. Furthermore, the developed client may be applied to any operating system, without developing different versions of the client for different operating systems. This greatly simplifies the client development process, reducing the development difficulty and improving the development efficiency.

In addition, accessing the resources of the operating system may be controllable when calling a service component by the script object. The user may set a different security level settings which may selectively dictate the service components accessible by the script object in the client. In comparison, all resources of the operating system may be accessed by directly calling SDK of the operating system. Thus, by controlling access to the resources of the operating system, according to the security level settings, risky operations are reduced, and the security may be greatly improved.

It should be understood by those skilled in the art that, all or part of the steps of the above embodiments may be implemented by hardware, and may also be implemented by virtual hardware instructed by a program. The program may be stored in a computer-readable storage medium, and the storage medium may be, for example, a read-only memory, a magnetic disk or an optical disc.

What is described above are only specific embodiments and is not intended to limit the present disclosure. Any change, equivalent substitution and improvement made within the spirit and principle of the present invention all fall within the scope of protection of the present disclosure. The foregoing detailed description has described only a few of the many possible implementations of the present disclosure. For this reason, this description of example embodiments is intended by way of illustration, and not by way of limitation. The methods, devices, and logic described above may be implemented in many different ways in many different combinations of hardware, software or both hardware and software.

1. An extension method for a browser-based application, comprising:
generating, in a first desktop space, a first start item pointing to the browser-based application, the first start item configured to trigger a start request in response to execution of the first start item;
generating, in a second desktop space, a second start item pointing to the browser-based application, the second start item configured to trigger the start request in response to execution of the second start item;
determining a source of the start request in response to receipt of the start request, wherein the source of the start request is one of the first start item or the second start item;
loading a page file, loading a browser core and embedding a script object into the browser core in response to receipt of the start request of the browser-based application, wherein the script object is configured to interact with a service component in a running environment of the browser-based application;
parsing the page file by the browser core, and generating and displaying a corresponding application interface;
receiving a request from the application interface;
calling the service component according to the received request and returning a call result to the application interface, by the script object;
displaying the application interface in the first desktop space if the start request is from the first start item; and
displaying the application interface in the second desktop space if the start request is from the second start item.

2. The extension method for the browser-based application according to claim 1, wherein the page file is a file formed by a text markup language definition.

3. The extension method for the browser-based application according to claim 1, wherein the page file is stored in a user storage space, and the method further comprises, after loading the page file:
reading version information of the browser-based application from the page file;
inquiring a server about whether there is a latest version of the browser-based application;
prompting a user to download the latest version of the browser-based application, and downloading a page file of the latest version of the browser-based application from the server in response to a selection by the user to download the latest version of the browser-based application.

4. The extension method for the browser-based application according to claim 1, wherein the page file is an encrypted page file, and the loading the page file comprises:
decrypting the encrypted page file and loading the decrypted page file.

5. The extension method for the browser-based application according to claim 1, wherein the service component comprises at least one of a network service component, a storage service component, a process or thread service component and a media service component.

6-7. (canceled)

8. The extension method for the browser-based application according to claim 1, further comprising: adjusting the application interface according to a first interface style of the first desktop space if the start quest is from the first start item.

9. The extension method for the browser-based application according to claim 1, further comprising: adjusting the application interface according to a second interface style of the second desktop space if the start quest is from the second start item.

10. The extension method for the browser-based application according to claim 1, further comprising:
storing configuration information of the browser-based application in a file folder named according to an identifier (ID) of the browser-based application; or
storing the configuration information of the browser-based application in a shared storage space located according to the ID of the browser-based application.

11. The extension method for the browser-based application according to claim 1, further comprising, in response to receipt of the start request of the browser-based application, judging whether a server is logged in, performing a login operation if the server is not logged in, and acquiring a notification from the server indicating successful login of the server.

12. An extension device for a browser-based application, comprising:
a main process module, a loading module, a browser core, a script object processing module, an interface processing module, and an installing module, wherein
the main process module is configured to call the loading module in response to receipt of a start request of the browser-based application;
the loading module is configured to load the browser core and embed the script object processing module into the browser core;
the loading module is further configured to load a page file according to the start request and transfer the loaded page file to the browser core;
the browser core is configured to parse the loaded page file, generate an application interface and transfer the application interface to the interface processing module;
the interface processing module is configured to display the application interface;
the script object processing module is configured to receive a request from the application interface, execute a service component according to the received request, and return a result to the application interface;
the installing module is configured to generate, in a first desktop space, a first start item pointing to the browser-based application wherein execution of the first start item triggers the start request;
the installing module is further configured to generate, in a second desktop space, a second start item pointing to the browser-based application wherein execution of the second start item triggers the start request;
the main process module is further configured to determine a source of the start request in response to receipt of the start request;
the interface processing module is configured to display the application interface in the first desktop space if the source of the start request is the first start item; and
the interface processing module is configured to display the application interface in the second desktop space if the source of the start request is the second start item.

13. The extension device for the browser-based application according to claim 12, wherein the page file is a file formed by a text markup language definition.

14. The extension device for the browser-based application according to claim 12, wherein the page file is stored in a user storage space, and the loading module is further configured to
read version information of the browser-based application from the loaded page file;
determine, by querying a server, a latest version of the browser-based application;
prompt a user to download the latest version of the browser-based application if a version of the browser-based application is earlier than the latest version, and download a page file of the latest version of the browser-based application from the server in response to selection by the user to download the latest version of the browser-based application.

15. The extension device for the browser-based application according to claim 12, wherein the page file is an encrypted page file, and the loading module is further configured to decrypt the encrypted page file and load the decrypted page file.

16. The extension device for the browser-based application according to claim 12, wherein the service component comprises at least one of a network service component, a storage service component, a process or thread service component and a media service component.

17-18. (canceled)

19. The extension device for the browser-based application according to claim 12, wherein the interface processing module is further configured to adjust the application interface to a first interface style of the first desktop space if the source of the start request is the first start item.

20. The extension device for the browser-based application according to claim 12, wherein the interface processing module is further configured to adjust the application interface to a second interface style of the second desktop space if the source of the start request is the second start item.

21. The extension device for the browser-based application according to claim 12, wherein the main process module further comprises a login unit configured to judge whether a server is logged in, in response to receipt of the start request of the browser-based application, perform a login operation if the server is not logged in, and acquire a notification from the server after the server is logged in successfully.

22. The extension device for the browser-based application according to claim 12, wherein the installing module is further configured to:
store configuration information of the browser-based application into a file folder named according to an identifier (ID) of the browser-based application; or
store the configuration information of the browser-based application into a shared storage space located according to the ID of the browser-based application.

23. The extension device for the browser-based application according to claim 12, wherein the main process module further comprises an exit unit configured to:
in response to receipt of an exit request for the browser-based application determine if the browser-based application is being executed according to a start item from the first desktop space;
move execution of the main process module as a background execution if the browser-based application is being executed according to the start item from the first desktop space.
